(19) United States
(12) Patent Application Publication
(10) Pub. No.: US 2024/0185355 A1
(43) Pub. Date: Jun. 6, 2024

(54) DIGITAL LIFE AND/OR HEALTH CLAIMS PROCESSING SYSTEM INTEGRATING MULTIPLE CLAIM CHANNELS, AND METHOD THEREOF

(71) Applicant: Swiss Reinsurance Company Ltd., Zürich (CH)

(72) Inventors: Sourav SHAH, Zürich (CH); Benjamin LYNCH, Zürich (CH); Lakshmi Narasimhulu GUJJULA, Zürich (CH)

(73) Assignee: Swiss Reinsurance Company Ltd., Zürich (CH)

(21) Appl. No.: 18/439,432

(22) Filed: Feb. 12, 2024

Related U.S. Application Data
(63) Continuation of application No. PCT/EP23/68459, filed on Jul. 4, 2023.

(30) Foreign Application Priority Data
Jul. 20, 2022 (CH) 000863/2022

(51) Int. Cl. G06Q 40/08

(52) U.S. Cl. CPC G06Q 40/08

(57) ABSTRACT

A digital health or life claim processing system providing electronic integration of multiple digital automated claims channels, in which a digital claims channel includes a claims data set, a policy data set regarding a claim event and/or a services data set, and processing one or more claims of a customer based on at least one claims channel related to the customer, the system including a cloud-based infrastructure platform accessible via a digital network, which hosts a storage module, a data modelling module, a claims processing module, and a communication module, and at least one data transmission interface for exchanging data and/or information provided by at least one user device with the infrastructure platform.

### CROSS-REFERENCE TO RELATED APPLICATIONS

This application is a continuation of and claims benefit under 35 U.S.C. § 120 to International Application No. PCT/EP2023/068459 filed on Jul. 4, 2023, which is based upon and claims the benefit of priority under 35 U.S.C. § 119 from Swiss Application No. 000863/2022, filed Jul. 20, 2022, the entire contents of each of which are incorporated herein by reference.

### FIELD OF THE INVENTION

The present invention relates to a digital life or health claims processing system for integrating multiple digital claims channels and a method of the digital claims processing system comprising one platform for several risk coverage models and claim types for providing communication between the multiple claims channels of the several risk coverage models and claim types. In particular, the invention relates to a digital claims processing system and method based on a cloud-based infrastructure platform for facilitating collaboration between user devices of multiple users and stakeholders involved in the processing of claims related to a claim event, like an illness and/or injury and/or critical illness and/or death, or another compromised health condition or other negative body impact incidence.

### BACKGROUND OF THE INVENTION

Over the last century the insurance business has grown into a diverse and widespread industry with numerous products, services, business models and capabilities for business entities, government units and individuals alike. Small insurance groups, large commercial insurers and reinsurers continuously modify and improve their products and risk coverage packages according to the needs of their customers and technological advancement. Besides mainstream risk protection covering for example life, health, disability, real estate, automobile, travel or legal costs, specialty insurances for unique objects and activities cover for example plants, special talents, body parts, or weddings. A large number of stakeholders is in involved in the insurance business. In addition to the customer ordering an insurance product and the insurance carrier providing payment in case of an insurance claim event, there are underwriting agents, independent insurance brokers, capital providers, risk advisors and others. Customers usually have a portfolio of various risk coverage policies for different subjects and activities concluded with several insurance service providers, which results in various claims channels for resolving an insurance claim in case of a claim event.

Claim processing is the most important point at which insurers interact with their customers, but it has historically been an area of underinvestment and technological backlog. Automated electronic claim systems have often been introduced by the risk-transfer industry with little awareness of the needs of life and health risk cover or the specific considerations of a specific market, as e.g. the Australian market. Further, filling out forms to file insurance claims is notoriously time-consuming for both, policyholders, and insurance personnel. This is not surprising given that countless documents have to be processed to provide a broad range of detailed information about the claim event, the resulting damage and loss of value for each claim channel. At the same time, there are always new and changing regulations, improved insurance products outdating existing policies and changing life circumstances. Finally, customers have high expectations towards timeframes for settling insurance claims, transparency of the claim processing and convenience of their involvement. There are many players involved in the claims management: from the policyholder to the clerk at the insurance company to external service providers, appraisers, and legal experts. Claims processing is one of the most important touch points in the customer journey, which determines customer satisfaction and loyalty. On the other hand claims processing and the associated workflows are a large cost factor for insurance companies and demand a high degree of collaboration across various business units.

New technologies open up new possibilities in the field of claims management. Insurance companies switched to claims processing software to digitally manage insurance data, handle policy and claims documents, interact with their customers and track the status of claims processing. Concluding new contracts and managing existing ones, comparing offers, submitting invoices, and reporting claims in a digital way became an important part of the communication between customers and insurance providers. For the insurance industry, digitization is therefore an essential tool for increasing efficiency, optimizing processes, and reducing costs. A key driver of this development is data related to insurance risks, damage specifications or customer circumstance. For the insurance industry, data has always been an essential part of any business activities, particularly for risk analysis, stocktaking, and pricing development. Modern data analytics harness the data to make informed decisions and better understand what products and services are successful.

Various digital claim processing systems or risk assessment systems based on data analytics have already been developed. For example, EP2631858A1 shows a system for insurance claims processing, which extracts claim data from one or more data sources to obtain a consolidated claims record and removes noise from text data of the consolidated records to obtain a claim dataset. U.S. Ser. No. 11/170,450B1 shows a data processing system for insurance claims analysis and adjudication for obtaining policy coverage data for various insurance policies and insurance claim data associated with an insured user. The system analyses the insurance claim data using machine learning models to identify coverage of a claims event by a respective insurance policy. US2016/0055589A1 discloses a system to predict and identify claims that have a high likelihood of exceeding a predetermined limitation in a given excess workers' compensation insurance policy and to automatically indicate possible intervention strategies to mitigate potential claims costs. The processing system is based on various statistical and machine learning algorithms and allows to electronically display and attach the results to a business process.

A system for evaluating an insurance claim, as presented in US2022/0044328A1, comprises: (i) extracting data features for the insurance claim; (ii) processing the data features using a machine learning model to generate potential denial data objects for a propensity to deny data object; and (iii) processing potential denial data object using a mitigating model to identify at least one mitigating action configured to cure the potential issue associated with the at least one potential denial data object. Finally, WO2020/119119A1 shows a machine learning-based system for settling an insurance claim. When providing a claim settlement service for a customer, pre-processing diagnosis and treatment data are captured to obtain claim settlement audit information for settling a claim. Then, the claim settlement audit data are detected by means of a detection model obtained in advance by means of training so as to determine the authenticity thereof. Finally, the system performs corresponding processing according to the authenticity detection result.

However, poor data quality and multiple handoffs due to non-synchronized communication channels and missing interfaces between all stakeholders involved results in unnecessary duplicate work processes, make it necessary to provide repeated information from the customer and open doors for irregularities and fraud. This not only causes workflow interruptions, but also longer processing times and incorrect claim settlements. Having multiple processing unit for the multiple claims channels of an insurance portfolio leads to high costs and technical debt, which is unsatisfying for the customer and the insurance providers.

In summary, there is a need to simplify the claims handling process for the customer to be fast and transparent, facilitate communication and collaboration across the supply chain of risk coverage products and increase efficiency of claim processing across physical and virtual boundaries.

### SUMMARY OF THE INVENTION

It is one object of the present invention to provide a digital claims processing system and a method thereof for integrating multiple claims channels and processing one or more claims based on the multiple claims channels that is based on customer-centric principles for a satisfying customer journey and enables agile claims processing for transparent and flexible claims management. Further, the digital claims processing system and method should allow for improving digitization and automation in the claims handling process to align workflow process steps, provide efficient communication channels and facilitate decision making for claims settlement considerations. In particular, it is an object of the present invention to provide a digital claims processing system and a method thereof that improve data accessibility and data quality for data sets relevant for claims processing, avoid data duplication and data loss in the short- and long-term, and support data exchange across various claims channels.

According to the present invention, these objects are achieved, particularly, with the features of the independent claims. In addition, further advantageous embodiments can be derived from the dependent claims and the related descriptions.

According to the present invention, the above-mentioned objects are achieved by a digital claims processing system and a method thereof for automatically integrating multiple claims channels and processing one or more claims of a customer based on the multiple claims channels related to the customer. A claims channel includes a claims data set of claims characteristics related to a claim event, like a negative impact or a negative change of condition, a policy data set of policy characteristics related to a claim policy regarding the claim event, like risk coverage rules or limits, and/or a services data set of services characteristics related to claims services, for example provided by an insurance carrier or intermediate. Additionally, the claims channel can e.g. comprise a product data set of product characteristics of a risk-transfer structure as a product. A claims channels may include several claims data sets, policy data sets and/or services data sets. At least one of the claims data set, the policy data set and/or the services data set and/or the product data set can e.g. include measuring data for physical event or real-world object/individual characteristics parameter values quantifying the claims event and/or the physical impact of a loss event to said real-world object or individual or living thing, wherein the measuring data is captured by measuring devices or sensors e.g. associated wearables or telematics or laboratory devices capturing body related measuring parameter values or in the event of a natural event with appropriate measuring stations capturing e.g. weather related measuring values, temperature, wind speed etc. For example the physical characteristics values indicate a damage or injury/illness extent, event impact details like disease/illness/injury event parameters or natural catastrophe/natural event parameters, event circumstances like human interaction documentation or monitoring data, or health condition parameters, etc. As an embodiment variant, where the claims are e.g. related to death and terminal illness, measuring parameters may not be needed or only in the framework of a diagnosis or diagnostic notification. Such data can e.g. be accomplished by capturing data from birth, death and/or marriage registries to allow automatic confirmation of the occurrence of the death. In some cases, the system can e.g. also rely on capturing data from medical reports such as X-rays and doctor's certificates to achieve an automated decision of the outcome. Captured medical reports may be filtered rule-based where the system automatically interprets data points from the reports to provide a better assessment decision.

The digital claims processing system according to the invention comprises a cloud-based infrastructure platform accessible via a digital network and is hosting a storage module, a data modelling module, a claims processing module, and a communication module comprising a signal generator. Further, the digital claims processing system comprises at least one data transmission interface for exchanging data and/or information provided by at least one user device with the infrastructure platform via the digital network. Data and information may for example be provided by user devices of a customer. The customer for example initiates a claims process and provides data for the claims data set. Further, user devices of a service provider like an insurance broker, an appraiser or specialist, an underwriter or an insurance carrier, may for example provide data and information about the claim event, the risk coverage conditions, settlement requirements, etc. for the policy data set and/or the services data set. The at least one data transmission interface is realized as a shared boundary between the cloud-based infrastructure platform and links the user devices and with the cloud-based infrastructure platform via the digital network. Particularly, the data transmission interface can be realized as an application programming interface (API) for allowing applications and modules of the infrastructure platform to communication with applications of the user devices. The user devices may for example be a smartphone or laptop of a customer, a computer system of a services provider or a digital network device of an insurance carrier. The user devices may for example run a common type of digital claims processing application as mentioned earlier, which can be linked to the cloud-based infrastructure platform by the data transmission interface. The digital network may be provided by a secured internet environment and the user devices may be realized by web-enabled devices accessing the internet environment.

The inventive system has, inter alia, the advantages to technically (1) enable the reuse existing capabilities (e.g. cloud tech and data modelling), (2) provide a single automated claim system for all policies and claim types irrespective of the policy source or risk structure, and (3) provide an API based approach for scalability and case of integrations. Technical key design principles for the claim processing capabilities, inter alia, include (1) providing ownership and visibility of the claims portfolio, (2) ensuring that all processed claims remain in focus with flexibility in the management of the portfolio depending on the needs of the claim and customer, (3) adaptable to meet the requirements of the Life Insurance Code of Practice with the allowance for future adaptability as the Code should change, (4) supporting flexible, agile and flexible working through in-built dashboards on claims durations and SLA management, (5) reporting suites to enable the tracking of claim conditions, occupations, portfolio sizes, product types, and claims trends, and (6) and ensuring case of access for individual product features to be incorporated into the claims assessment. By introducing a more flexible and agile technical approach to automated claim processing, this allows for human claims specialists to be able to manage their own portfolio, with targeted huddles each morning to talk through their work with the team. Further, the digital system allows for users to automate review and monitoring of their claims portfolio in size, product, and duration as well as focus on individual workflow items to target shorter durations in decision times. The system also allows for flexibility and technical adaptability to consider claim requirements based on the individual need of the claim or due to a focus on the specific needs of the customer. Monitoring and reporting features can easily be implemented in line with regulatory requirements as well as the needs of the claims specialists and claims manager. The standard reporting automatically can indicate claims acceptance rates, workflow trends, and SLA adherence by individual or portfolio. To ensure that the technical solution meet these technical requirements, rigorous user acceptance testing was conducted with the claims team to ensure that the inventive system is able to deliver against the concept requirements. In particular as a supporting platform to automated claim management, the inventive system allows for greater visibility over a complex claim portfolio and technically enables a more strategic approach to automated claim data processing and assessment. More particularly, the use of the inventive system allows by technical means (1) a significant reduction of the average open aged claims (typically up to 60%), (2) a significant reduction of the claims decision times (typically around to 58%), (3) SLA adherence rising to 99%, and (4) a significant reduction of the time required to produce regulatory reporting for claims (typically from weeks to days). Finally, the inventive system newly allows to provide an automated technical system for (1) online lodgment and tracking of claims, (2) technical integration with ID check provider systems, (3) easy technical integration with death notification service systems, (4) easy technical integration with medical service provider systems, (5) application of of AI/ML to provide the claims assessors to automatically detect and reduce frauds, validate product rules, enable OCR of documents to improve data quality and efficiency and validate product rules, and (5) easy technical integration with Eco system provider systems.

According to the invention the data modelling module comprises a data validation structure for validating data of characteristics values of the claims data sets, the policy data sets and/or the services data sets received via the data transmission interface, wherein validated data of multiple claims channels of the customer are stored as structured data sets in the data storage module. That means there is for example a structured claims data set, a structured policy data set and/or a structured services data set. The data validation structure ensures data integrity and for example compares value data for the same characteristics used in different data sets, standardizes data, extracts data from information, reviews data formatting, checks compatibility and compliance, etc. Preferably, the data validation structure provides a common data standard for the structured data sets. Advantageously, the structured data sets are combined as one integrated claims processing data set for the insurance portfolio of a customer. The claims processing module comprises a processing and analyzing structure designed for analyzing the structured data sets according to claims requirements defined in the claims channel, and for defining a current claim processing status. The claims requirements for example are determined by requirements data included in the structured policy data sets and/or the structured services data sets and for example define risk management rules for processing the claims of a customer. The communication module provides a digital communication signal representing the current claim processing status via the signal generator to a user device within the digital network. Thus, all stakeholders in the claims management process can quickly be informed about the current status of a claim and take action if needed.

The digital claims processing system and the method thereof according to the invention provide one platform as a technological tool for coordinated claims handling of various different claims through various different claims channels of the same customer. The digital claims processing system provides a tool to translate the information about a real-world claims event causing a negative impact on a customer and defined by the measurements of physical claim event characteristic into a quantified damage compensation based on the claims requirements for example defined by measuring data for physical characteristics values quantifying a life or health exposure and/or a probability for an occurrence of a life or health risk event. The digital claims processing system and the method thereof provide an in-built automation process to manage approval processes with increased efficiency and risk reduction and allows for accurate monitoring and control of the claims process. The integrated claims processing data sets reduce handoffs between customer, intermediates and insurance carriers for a transparent customer experience and minimizing errors. The integration of various claims channels by the cloud-based infrastructure platform makes onboarding of new products and partners easy and reliable. The digital claims processing system is an agile tool for claims management that is easily kept up to date with innovative insurance products and technical advancements by updating the models, structures and algorithms of the cloud-based infrastructure platform and applying the updated system to the integrated claims processing data set which compiles all the claims channels of a clients insurance portfolio. The digital claims processing system provides holistic and transparent risk coverage and claims management.

In an embodiment variant of the digital claims processing system and the method thereof at least the policy data set includes measuring data for physical characteristics values quantifying an illness/accident event exposure or a natural hazard exposure and/or a probability for an occurrence of an illness/accident event or a death event or a natural hazard captured by event or object or individual/body measuring and sensor devices. The measuring data of physical characteristics values for example includes data of parameter values for the strength and frequency of illness/accident or natural catastrophic events like illnesses, diseases, accident, death, storms, floods, ice, fires, draughts, etc., and/or for example data on temperature, humidity, storm strength, tide height, sun radiation strength, etc. Further, the measuring data may comprise statistical data derived from long-term measurements and analytics of such data. The assessment of accident/illness/death exposure or natural hazard exposures and/or a probabilities for an occurrence of an accident/illness/death or natural hazard is incorporated in the policy data for example e.g. in form of geographical claim validity boundaries, exclusion of specific event forms or natural hazards, time limits for event and/or hazard exposure and the like. Such policy rules can be derived from the measuring and analysis of past accident/illness/death events or natural hazard events and may be applied to future policies. For example, in the case of accident/illness/death events e.g. measuring devices or sensors associated with wearables or telematics or laboratory devices capturing body related measuring parameter values can be comprised by the system, whereas in the case of natural catastrophic events, catastrophic sensor devices can e.g. be realized as geo risk measuring tools specifically designed to provide swift measuring overviews and risk assessments/measurements of natural hazard exposures and occurrence probabilities, worldwide. The sensor data can e.g. be used to improve pricing and reward customers with discounts associated with risk-transfer structure. The sensor devices are e.g. used to measure and assess the risk, i.e. the physically measurable probability value for the occurrence of a risk-transfer event given by the policy data, from individual locations to entire portfolios/allocations of locations and objects, by combining physical hazard measurements, loss impact measurements, exposure measure and individual risk-transfer characteristic and information data. The catastrophic sensor devices use satellite imagery, maps, and data capturing, inter alia, climate change, catastrophic event impact, and population density measures (e.g. night-light measures). High-resolution sensory allows including storm surge, tsunami, lightning and volcanic hazards measurements and real-time capturing. Furthermore, the same measuring data may be used in claims channel data sets and/or may be provided to the cloud-based infrastructure platform directly via a data transmission interface for integration into the structured data sets or into the integrated claims processing data set.

In a further example embodiment of the digital claims processing system and the method thereof a plurality of combined structured data sets of a plurality of customers is stored in the data storage module. Likewise, a plurality of integrated claims processing data set is stored in the data storage module. The plurality of such data sets can advantageously be used as an information or data pool as a basis for improving the claims management process of a specific claims request. Analogue or similar data sets may serve for comparison evaluations and as a baseline for claims analysis. Further, in case of policy or service updates for existing claims channels, all the data sets and characteristics values for the plurality of customers can be updated synchronously with update data information for the structured data sets. Also, the multiple claim channels integrated by the digital claims processing system may include policy data sets of policy characteristics and service data sets of services characteristics related to historical, outdated or retired claim policies. Thus, the digital claims processing system can easily process claim requests for old and retired claim types and can suggest updates and improvements for the insurance portfolio of a customer. Additionally, efficiency and automation in claims management is augmented.

In a further example embodiment of the digital claims processing system and the method thereof the data modelling module comprises a machine learning structure for analyzing data sets of the digital claims channels, wherein the machine learning structure is realized as a supervised or unsupervised machine learning algorithm to analyze input data sets and provide validation for the data of the input data sets, wherein the data modelling module provides the validated data for a structured data set as output data. For example, for the automated validation for the data of the input data sets, the digital system can at least comprise optical data recognition (OCR) structures and/or data mining structures to automatically recognize and/or classify and/or associate data blocks of the input data sets. For example, the machine learning structure classifies data of characteristics values to determine their allocation to claim channels, compares data for streamlining data formats across data sets, assesses data conformity, compliance and accurateness, labels data according to hierarchical claims levels, eliminates noise, and more. The plurality of data sets stored in the storage module may serve as a training pool for the machine learning structure to improve the data validation process for each individual data set. The machine learning structure is for example realized as a classification structure e.g. based on a Naive Bayes algorithm, logistics regression algorithm, K-nearest neighbors algorithm, random forest algorithm, rule-based classification algorithm, or similar algorithms, or as a cluster structure e.g. based on a partitioning algorithm, hierarchical-based algorithm, constraint-based algorithm or similar algorithms. Further, the data modelling module may comprise a machine learning structure for dimensionality reduction at least for the integrated claims processing data set. The machine learning structure is realized to select and/or extract data variables from the claims channels' data sets and/or the structured data sets to simplify the integrated claims processing data set. It can, for example, be realized as a linear discriminant analysis algorithm, variance threshold algorithm, ANOVA algorithm, recursive feature elimination algorithm, principal component algorithm or similar algorithms.

Additionally or alternatively, the data modelling module may comprise a text mining structure for analyzing textual data of the claims channel data sets. The text mining structure is realized as an information extraction algorithm to identify and categorize claims, policy and/or services characteristics in the textual data as validated data, wherein the data modelling module provides the validated data for a structured data set. The text mining structure is for example realized as a Naive Bayes algorithm, decision tree algorithm, clustering algorithm or the like. The machine learning structure and the text mining structure allow for improved accuracy of the claims analysis by verifying and validate the data used for the analysis. They provide a smart solution for managing claims for policies sold via various different channels, particularly in cases wherein the claims may be above the authority of the personal handling the claims. Further they accelerate digitization of the claims management process and help reducing costs of claims handling. Most important the machine learning structure and the text mining structure support capturing adequate and reliable data for an efficient digital claims process and satisfying results for the customers.

In still a further example embodiment of the digital claims processing system and the method thereof the processing and analyzing structure of the claims processing module comprises an algorithm for defining the claim processing status. Additionally, the processing and analyzing structure may comprise several workflow algorithms, wherein each workflow algorithm defines a processing step of a claims processing workflow. For example, the processing and analyzing structure comprises a workflow algorithm at least for the workflow processing steps of recording of a claims submission by a customer, analysis of missing data information, analysis of incorrect data information, analysis of claim entitlement and recording of a settlement decision. The workflow algorithm for the recording of a claims submission for example focusses on the initiation of a claims processing case, provides labeling the claims processing case for further processing and identifies policies related to the claims processing case. The workflow algorithm for the analysis of missing data for example focusses on existence or sufficiency of claims data to satisfy policy requirements and identify missing claims data for claims characteristics needed to comply with policy requirements. The workflow algorithm for the analysis of incorrect data for example focusses on the comparison of the claims data, policy data and/or services data with data of other claims channels of the insurance portfolio of the customer or data of measuring devices measuring physical characteristics related to the claims event causing the claim submission. Further, the workflow algorithm for the analysis of incorrect data may identify inconsistencies and quantify any deviation between data information. The algorithm for the analysis of claim entitlement for example focusses on the aligning of the structured claims data set with the structured policy and/or services data sets to approve or reject the claims request of the customer and identify any misalignment as basis for claim rejection. The workflow algorithm for recording a claim settlement for example focusses on determining type and amount of indemnification and monitoring deadlines. Each of the algorithms of the claims workflow can be amended individually. Also, additional workflow steps are easily added and integrated to the processing and analyzing structure if needed. The workflow algorithms of the claims processing workflow advantageously may be linked with the algorithm defining the current claim processing status and contribute their analysis for further processing by the claim processing status algorithm.

In a further example of the digital claims processing system the claims processing module comprises a prioritizing structure for identifying and prioritizing outstanding work tasks in a claims processing workflow. The prioritizing structure is linked to the processing and analyzing structure to receive information about the current claim processing status and the analysis of the workflow algorithms. The prioritizing structure evaluates the priority of data insufficiencies like non-existing claims data, shortcoming claims data, inconsistent data, misalignment of data, etc. The priority can for example be determined by using a priority classification that may be associated with the policy data set or the services data set. The information about an outstanding work task may be added to the current claim processing status and can be provided to the user devices of customers and/or services providers via the digital network in form of a communication signal. This further increases transparency and compliance of the claim management process and accelerates the claim handling by avoiding handoffs between intermediaries in the risk coverage supply chain.

In a further example embodiment of the digital claims processing system and the method thereof the cloud-based infrastructure platform hosts a tracking module designed for tracking the claim processing status and creating notification signals regarding the claim processing status, incorrect claim data/information, missing claim data/information, outstanding work tasks and/or work task allocation. The tracking module communicates with the processing and analyzing structure of the claims processing module and transforms received information about the current claim processing status and outstanding workflow tasks into a corresponding notification signal. Additionally, the tracking module may be realized to identify responsibilities for outstanding tasks and to create an information signal assigning a work task to an associated responsible personal or customer. The responsibility of work tasks may be included in the data classification and can be extracted by the tracking module. The claims processing module or the tracking module comprise a notification algorithm, which is designed to create a task notification signal for requesting missing claim data and/or information and for providing the task notification signal to the communication module and the signal generator, respectively, for transmission to the user device of a user assigned with the work task. The tracking module and the notification algorithm facilitate digital claims processing, enhance the understanding of the claims management process and assist users of the digital claims processing system in supporting efficient claim handling. Also, the tracking module and the notification algorithm improve the data quality received by the users by providing clear and actionable information.

The digital claims processing system, and particularly the tracking module and the notification algorithm, provide a technical tool to prove an insurer cares for their customers and invests in the communication quality along the insurance journey. The system provides a customer centric claims collaboration capability which enables a customer to: (1) track a claim, (2) see the type of outstanding information and upload documents directly to the digital claims processing system while bypassing any intermediaries or handoffs, (3) access information related to recovery, settlement and other support services, and (4) communicate directly with the claims assessor, like the insurance carrier, to enable efficient collaboration by breaking down communication barriers to enable a better outcome for customers.

In yet a further example embodiment of the digital claims processing system and the method thereof the cloud-based infrastructure platform can host a timeline module configured for indicating key data of the claims processing data set, wherein the key data at least indicate a policy activation date, claim event date, a claim submission date, and a claim settlement date. Further, the cloud-based infrastructure platform hosts a dashboard module, which is linked to the storage module, the claims processing module, the tracking module and/or the timeline module. The dashboard module is configured to create a visual display of at least the current claim processing status and/or communication signal data. The visual display may visualize the notification signal of the tracking module, a workflow illustration based on the data provided by the processing and analyzing structure, a timeline illustration based on the data provided by the timeline module and/or any other communication signal generated by the cloud-based infrastructure platform. The dashboard module may be realized to interact with a display of the user devices to present the visualizations. The dashboard module facilitates easy communication with the customer and service providers. It shows all open claims and timeframes. Service providers may use the dashboard similar to an agile board and go through open claims and work tasks every day and call out blockers in the claims management process.

In summary, the digital claims processing system and the method thereof according to the invention is a digital claim and claim management system, inter alia, native hostable on on-demand cloud computing platforms, for example the cloud services Amazon Web Services (AWS), AZURE or Google's cloud platform (GCP) for entering and tracking a claim against an order and managing claim settlement. Thus, the digital claims processing system provides an automated system of identifying, controlling, and resolving demands of customers to recover losses of said customers by an insurance services provider and insurance carrier, respectively. The cloud-based infrastructure platform of the digital claims processing system advantageously provides could-based machine learning and artificial intelligence data processing technology, and preferably an API-based architecture enabling easier participation in insurance ecosystems and insurance digital marketplaces. Configurable smart structures enable the insurance services provider to easily manage business rules and data without code change. The cloud based architecture combines claims' management, data visualization, workflow management, and document management into one platform. The digital claims processing system comprises in-built process automations to manage approval processes increasing efficiency and risk reduction. Further, it allows to provide a flexible way in the workflow of managing claims using dashboards to visualise open claims and work tasks. Another advantage of the openness of the platform is that it allows to integrate with multiple policy channels, for example by using API tools or CSV files, ensuring a singular claims management system. The invention provides the singular digital claims processing system to assess various risk coverage modes such as life, TPD, trauma, funeral, and accident claims. Further, the inbuilt claims validation, data visualization, workflow, work allocation and document management capabilities eliminate system handoffs and reduce tech debts. Finally, the digital platform provides a common data standard ensuring a more scalable design with a special focus on data quality. This ensures higher scalability, allows to capture relevant data fields using standard lists to improve data capture and analysis, and improves data quality using notification signals for potential data issues (e.g. if incident date is before cover start date), by using data from claims, policy, and services domains to improve data quality.

In addition, the digital claims processing system is based on customer-centric principles, where customer feedback dashboards show how customers feel in the claiming process, allowing a constant improvement process of within the platform development cycle resulting in shorter claims handling time and hence less waiting time for customers. Built-in algorithms to help prioritize pending claims, dashboards and timeline views enable visualization of data, and easy access to policy requirements ensuring a claim is assessed using appropriate rules.

### BRIEF DESCRIPTION OF THE DRAWINGS

Exemplary embodiments of the invention will be illustrated in the following drawings, which merely serve for explanation and should not be construed as being restrictive. The features of the invention becoming obvious from the drawings should be considered to be part of the disclosure of the invention both on their own and in any combination.

FIG. 1 shows a diagram schematically illustrating the basic units and interactions of a digital claims processing system according to the present invention, and explains the integration of multiple claims channels in the digital claims processing system. The digital system can e.g. comprise data interfaces to capture from a governmental or other public data source of data (as e.g. birth, death and/or marriage registry data bases) or AML/ITC databases, which can e.g. prevent the system of claim payment transfers going to e.g. sanctioned or red flagged individuals or fraudulent claim transfers.

FIG. 2 shows a schematic diagram of an example embodiment of a cloud-based infrastructure platform of the digital claims processing system illustrating the architecture of models, structures, and algorithms of the cloud-based infrastructure platform.

FIG. 3 shows a flow diagram of processing steps of the data modelling module of the cloud-based infrastructure platform illustrating a data processing flow of a method for a digital claims processing system according to the invention.

FIG. 4 shows an exemplary workflow diagram of workflow algorithms of the cloud-based infrastructure platform illustrating example workflow steps of a method for a digital claims processing system for integrating multiple claims channels.

FIG. 5 shows a diagram, schematically illustrating the inventive digital system in the embodiment variant with data interfaces to capture from a governmental or other public data source of data (as e.g. birth, death and/or marriage registry data bases and/or mortality and morbidity data) or AML/ITC databases. The patient healthcare ecosystem typically encompasses various different data sources providing an extended perspective of big data with its significant stakeholders and their diversified data sources (structured/semi-structured/unstructured). As an embodiment variant, the present invention also allows to capture the impact of big data in medicine and healthcare results by identifying new data sources such as social media platforms, telematics, wearable devices etc. in addition to the analysis of legacy sources that includes patient medical history, diagnostic and clinical trials data, drug effectiveness index etc. When the mixture of these data sources and analytics are coupled together, it provides an improved and extended source of information for health-care and medical data allowing to attain the inventive solution. As such, the inventive system is able to provide a scalable machine-learning-based life and health claim system 1 for processing and monitoring of complex, big medical data (BMG) and providing dedicated electronic detection signals triggered by measured and/or forecasted medical data pattern.

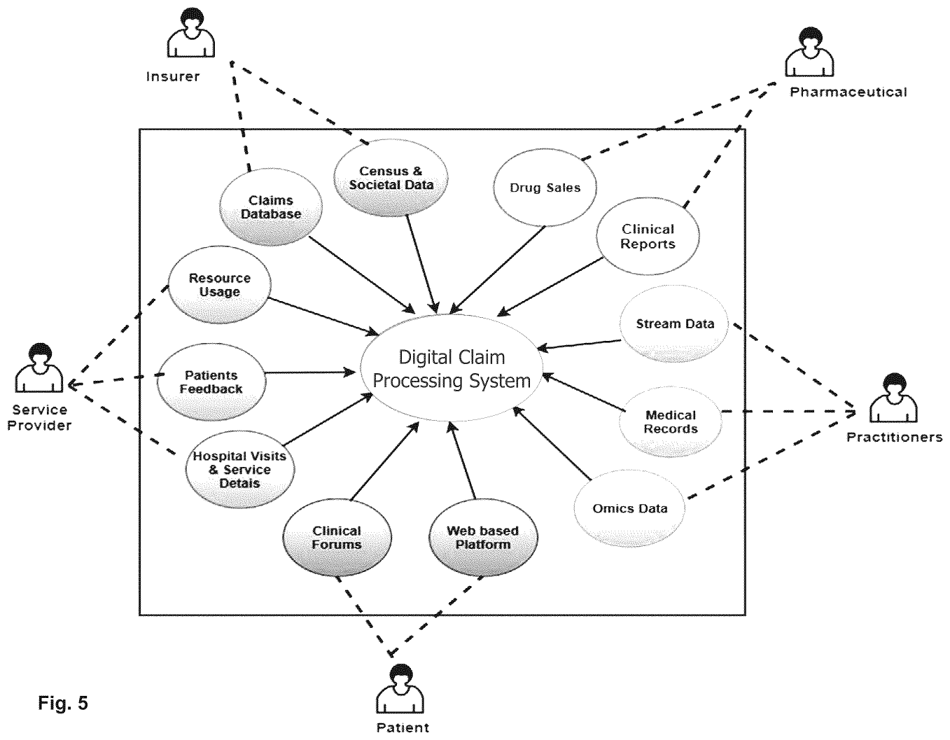

### DETAILED DESCRIPTION OF THE PREFERRED EMBODIMENTS

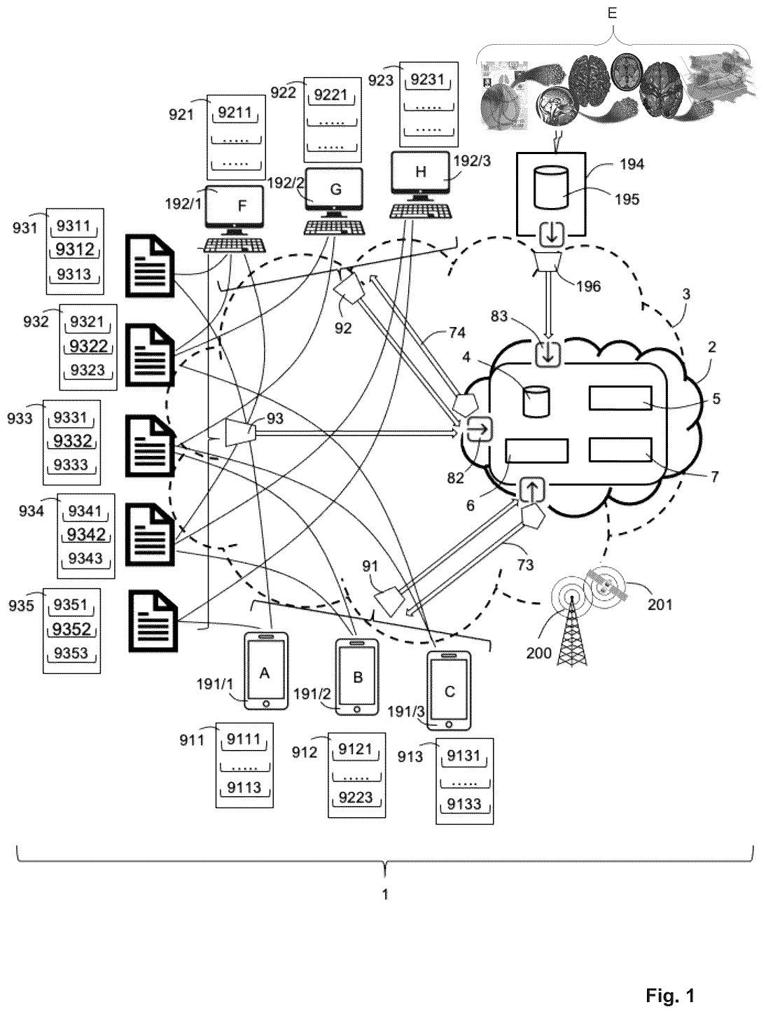

FIG. 1 schematically explains a digital claims processing system 1 for automatically integrating multiple claims channels and processing one or more claims of a customer based on at least one digital claims channel related to the customer in case of a claim event E according to the present invention. The digital claims processing system 1 comprises a cloud-based infrastructure platform 2 accessible via a digital network 3 and/or the worldwide backbone network internet. The cloud-based infrastructure platform 2 at least hosts a storage module 4, a data modelling module 5, a claims processing module 6, and a communication module 7 comprising a signal generator 71. The system 1 further comprises data transmission interfaces 81, 82 for exchanging data and/or information provided by user devices 191, 192 with the infrastructure platform 2 via the digital network 3. The data transmission interface 81 provides exchange with customer user devices 191/1, 191/2, 191/3, etc. providing claims data sets 91 about the claims event E, and the data transmission interface 82 provides exchange with service provider user devices 192/1, 192/2, 192/3, etc., which allow access to policy data sets 93 about a risk coverage policy and services data sets about services provided by the service provider. The data transmission interface 83 can e.g. provide exchange with a physical parameter measuring device 194 providing measuring data 196 for physical characteristics values quantifying the claims event E and/or the individual. It has to be noted, that in case of using measuring physical characteristics parameter values captured by measuring devices and/or sensors (e.g. associated with wearables and/or telematics) and/or laboratory devices, the realization of such a system having a direct sensory link to the physical reality may involve regulatory issues and may not be used by the system for the automated claims decisions, unless the measuring devices, as e.g. the wearables, used by the system are regulated as a medical device. The measuring device 194 can e.g. comprise a storage 915 for temporarily storing the measuring data 196. The data transmission interfaces are advantageously realized as an application programming interface (API) providing digital applications access between the infrastructure platform and user devices. The customer user devices 191 may for example be realized by a smart phone, tablet computer, lap top, personal computer or the like, and may be provided with display and keyboard function, and able to run an application interacting with the cloud-based infrastructure platform 2 The service provider user devices may for example be realized as a desk top computer, a network computer or the like, which for example may be running data management application to manage customer data. The inventive system 1 can e.g. be realized to comprise an automated selection and review engine. The system 1 automatically detects and labels claims based on set criteria with flags to trigger an expert reviewer where the criteria are classified not to be correct. The system 1 can e.g. automatically transfer claim data to be sent for review based on the set criteria in addition to auto-extraction of random sample for review.

As illustrated in FIG. 1, a customer may have several risk coverage policies possibly purchased from different service providers and may make use of additional services from additional service providers. Thus, the customer having a risk-transfer portfolio can e.g. have to deal with the several policies and services providers of each of the several digital claim channels on an individual basis. For example, the customer has to file a claims form for submitting a claim at an insurance broker, request an appraisal from a damage appraiser and file the appraisal, arrange for intermediate damage replacement, respond to inquiries of insurance broker and the insurance carriers, etc. As explained above such a prior art claims management concept is complicated, slow in claims processing, error-prawn, untransparent and cumbersome for the customer and the services provider. In contrast to that the digital claims processing system and the method thereof according to the present invention integrate multiple claims channels using the cloud-based infrastructure platform to simplify claims processing and support the customer throughout the claims recovery journey as a single point of contact for all of the customer's risk coverage models in the insurance portfolio.

For example, the risk-transfer (insurance) portfolio of a customer A includes a life risk-transfer based on parameter values given by a life risk-transfer coverage policy represented by the data values of a policy data set 931 and a health risk-transfer based on parameter values given by a life risk-transfer coverage policy represented by the data values of a policy data set 935. The risk-transfer (insurance) portfolio of a customer B may include a critical illnesses risk-transfer based on a critical illnesses coverage policy represented by a policy data set 933/1 and an accident or health risk-transfer based on an accident or health risk coverage policy represented by a policy data set 934. The insurance portfolio of a customer C may include a terminal illnesses risk-transfer based on a terminal illnesses risk-transfer coverage policy represented by the policy data set 933/2 and a life insurance based on a life risk coverage policy represented by a policy data set 932. The individual risk coverage policies for the individual customers are negotiated and established by individual services providers. For example, a service provider F created the health risk coverage policy for customer A, the life risk coverage policy for customer C, and the critical illnesses risk coverage policy for customer B. The service provider G may have created the terminal illnesses risk coverage policy for customer C, and provided additional information, e.g. in form of a third party risk assessment, for the life risk coverage policy of customer C. The service provider H may have created the health risk coverage policy for customer A, and provided additional information, e.g. in form of a damage/loss evaluation, for the health risk coverage policy of customer B. All the agreements and interactions of the customers and the risk-transfer (insurance) providers, respectively the insurance carriers, and the risk coverage policies represent digital claims channels for the customers as a basis for managing risk-transfer claims of the customers. For simplicity, the risk-transfer portfolios of customers illustrated in the diagram of FIG. 1 include only two insurances. However, in reality the insurance portfolio of customers includes several risk coverage products; in average one customer has about 6-8 insurances, and there is no limit in the number of risk coverage agreements for one customer.

For example, the accident policy data set 931 may comprise the following measuring data for the physical characteristics values: age of the insured person 9311, gender of the insured person 9312, probability for an occurrence of an accident type 9313, etc. The life policy data set 932 may comprise the following measuring data of physical characteristics values: age of the insured person 9321, measurable health condition parameter values of the insured person 9322, probability for a defined life expectancy of the insured person 9323, etc. The car policy data sets 933/1 and 933/2 may comprise the following measuring data of physical characteristics values: age of the insured car 9331, horsepower of the insured car 9332, probability for an occurrence of a total loss 9333, etc. The property policy data set 934 may comprise the following measuring data of physical characteristics values: age of the insured property 9341, size of the insured property 9342, probability for an occurrence of a natural hazard at the location of the property 9343, etc. The health policy data set 935 may comprise the following measuring data of physical characteristics values: age of the insured person 9351, measurable health condition parameter values of the insured person 9352, probability of a severe illness type of the insured person 9353, etc. Further, the claims data set 912, for example reporting the claims event E, e.g. an illness event impacting an individual or a wild fire damaging property of insured customer B, may comprise the following measuring data for the physical characteristics values of claims event E: in case of a health or life event, X-ray imagery data and/or laboratory measurements and/or diagnosis parameter values and/or measuring data form telematics' or wearables' sensors, or in case of a property of object impact imagery data of damaged property 9121, textual data 9123 listing damaged property inventory, etc. The claims data set 911, for example reporting a claims event of a car collision event, may comprise measuring data for the physical characteristics values of a speed at the time of collision 9111, a location of the collision 9113, etc. The claims data set 913, for example describing a claims event based on an illness of a customer, may measuring data for the physical characteristics values indicated by body function parameter data 9131, body imagery data 9133, etc. Further, the services policy data set 921 may comprise measuring data for physical characteristics values defining a maximum distance of travel for a service type 9211 and more, the services policy data set 922 may comprise measurable data in form of a number of service visits 9221 and more, and the services policy data set 923 may comprise measured data in form of disclosure of risk factor classifications 9231 and more. All these measuring data represent quantified values of physical parameters indicating the real-world characteristics of the claims, the policy and/or the services related to a claims channel.

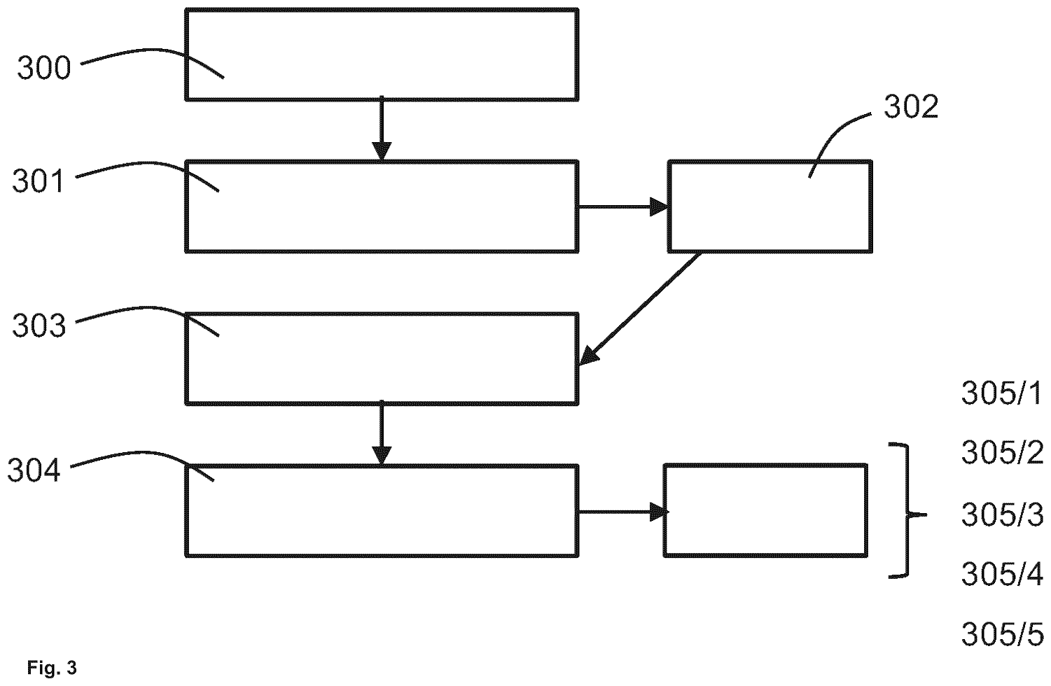

The data sets 91, 92 and 93 defining the claims channels are provided to the cloud-based infrastructure platform 2 via the digital network 3 and the data transmission interfaces 81 and 82 in a data set input step 300, as shown in FIG. 3. Also, measuring data sets 94 including measuring data for physical characteristics values quantifying a claims event, like the claims event E, are provided to the cloud-based infrastructure platform 2 via the data transmission interfaces 83. Preferably, the user devices 191, 192 and the measuring devices 194 are realized as web-enabled devices and the data transmission interfaces 81, 82, 83 of the digital claims processing system 1 are web-interfaces. The digital network 3 can be realized as a data transmission network or data transmission line, e.g. comprising a cellular mobile network 200 and/or a satellite transmission line 201 for the cloud-based infrastructure platform 2.

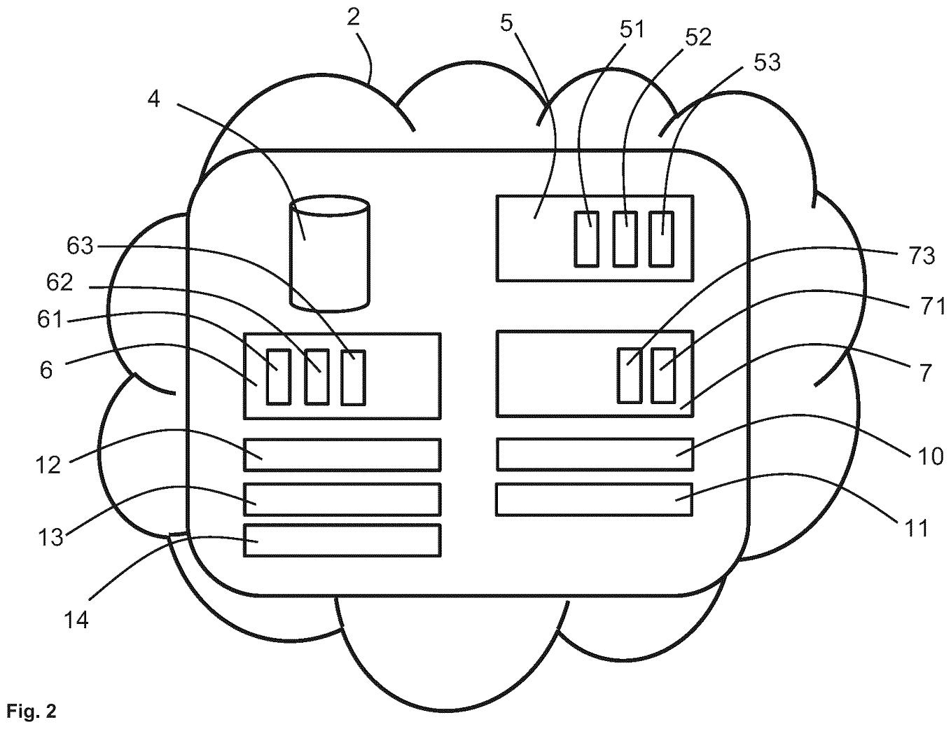

FIG. 2 schematically illustrates an example embodiment of the cloud-based infrastructure platform 2 as it can be used for the digital claims processing system 1 of the current invention and as shown in FIG. 1. The cloud-based infrastructure platform 2 advantageously is designed as a secured access platform, wherein each user/user device has a user account for the cloud-based infrastructure platform with assigned authentication and authorization credentials for authentication and authorization controlled network and platform access to the platform and the network, respectively. The cloud-based infrastructure platform 2 comprises the storage module 4, which is designed to store data sets and structured data sets of various types of data formats related to documents, text, images, videos, spreadsheets, etc.

Further, the cloud-based infrastructure platform 2 hosts the data modelling module 5 which comprises a data validation structure 51 for a validation step 301 validating data of characteristics values of the claims data sets 91, the policy data sets 92 and/or the services data sets 93 received via the data transmission interfaces 81, 82. Further, the data validation structure 51 may validate any data sets that are provided by the measuring devices 194. Validated data sets of multiple claims channels of a customer are stored as structured data sets 302 in the data storage module 4 in a data storage step 303, as shown in FIG. 3.

When a data set 91, 92, 93 or 94 is transmitted to the data modelling module by a user device 191, 192 or a measuring device 194 in the data set input step 300, the data modelling module 5 validates the data for example regarding format compliance, completeness, accuracy, classification, etc. and structures the data according to a consolidated data format used for the digital claims processing system 1. The structured data is stored in a structured claims data set 302, structured policy data set and structured services data set in the storage module 4, as explained above. In the validation step 301 the data modelling module 5 for example performs a code check which ensures that a data value is selected from a valid list of values or follows certain formatting rules. For example, a postal code is checked by comparing it against a list of valid codes. The same concept can be applied to other parameters. For example, the system can use of standardized ICD-10 codes to automatedly classify a claim cause. Further, a range check may be performed which verifies whether input data falls within a predefined range. For example, latitude and longitude are commonly used in geographic data. A latitude value should be between −90 and 90, while a longitude value must be between −180 and 180. Any values out of this range are invalid. A format check may examine if the type of data format follows a certain predefined format. A common use case is date columns that are stored in a fixed format like “YYYY-MM-DD” or “DD-MM-YYYY.” A data validation procedure that ensures dates are in the proper format helps maintain consistency across data and through time. For a consistency check for example a logical check confirms that the data has been entered in a logically consistent way. For example, it is checked if the policy start date is before the submission date of a claims form. A uniqueness check can ensure that an item is not entered multiple times into a data set. In summary, the data modelling module 5 provides the validated data for a structured data set. Advantageously, the data modelling module 5 combines the structured claims data set, the structured policy data set and/or the structured services data set to an integrated claims processing data set. The integrated claims processing data set also includes the structured measuring data for physical characteristics values quantifying a claims event and/or structured measuring data quantifying an event exposure and/or a probability for an occurrence of a risk event captured by measuring devices. The integrated claims processing data set can be described as a master data set of the insurance portfolio of one customer. The integrated claims processing data set can easily be updated and amended with information about additional claims channels and preferably also includes data about retired and outdated risk coverage products of the one customer. Further, the system can e.g. use APIs from automated policy administration systems automatically retrieving customer information at purchase of policy to look for disclosures of pre-existing conditions or potential non-disclosure. The system may have an issue, where customers do not declare their pre-existing conditions and hazardous occupations. Knowing the information, the system could have declined to cover the person.

In the example embodiment of a cloud-based infrastructure platform 2 according to the invention shown in FIG. 2, the data modelling module 2 comprises a machine learning structure 52 for analyzing data sets of the claims channels. The machine learning structure can e.g. be realized by integrating artificial intelligence (AI). Using AI to perform an initial assessment, the system 1 uses, for example, data from policy fields in connection with input data fields from claim form (either automated OCR or the client filling out a form, i.e. structured input data). Criteria can e.g. be defined to define what would require human intervention (client contact, decisions regarding disclosure and remedies under life insurance act) compared to what would only require a human review before making a decision on the claim. The digital claim system 1 can e.g. automatically identify and verify data details on the claim form such as the duration of the illness and draw a comparison with the statement of responses generated from the underwriting application to provide indications of potential disclosure issues. The machine learning structure 52 or artificial intelligence structure can e.g. be realized as a supervised or unsupervised machine learning algorithm to analyze input data sets 91, 92, 93, 94 and provide validation for the data of these data sets. The machine learning structure 52 provides the data modelling module 5 with the ability to learn automatically from previous processing of data sets and enhances the data validation step. The machine learning structure 52 may be based on machine learning algorithms as mentioned earlier. Particularly, the data modelling module 5 may comprise a machine learning structure for dimensionality reduction of the integrated claims processing data set, wherein the machine learning structure is realized to select and/or extract data variables from the claims channels data sets and/or the structured data sets 302 to simplify the integrated claims processing data set. The proposed inventive dimensional reduction transforms high dimensional representation of the integrated claims processing data set in low dimension representations. With the immense increase in high dimensional data in claims data, the need to develop an appropriate dimensional reduction technique suitable for this kind of data has become a technical necessity. Though, many prior art techniques are evolving continuously, these dimensional reduction techniques to not allow a suitable transformation of original claim data set having high dimensionality and conversion it into a new data set representing low dimensionality while preserving the original meanings of the data as much as possible. It is clear that low dimensional representation of the original data would help to overcome the issue of curse of dimensionality. The low dimensional data can be easily processed, analyzed, and visualized.

The inventive dimensional reduction technique provides automated transformation of the high dimensional claim data Y=[y₁, y₂, . . . , yₘ]∈R^{m×p} having p dimensions and m observations into low dimensional data Z=[z₁, z₂, . . . , zₘ]∈R^{m×k} where k<<p in ideal case. DRT can have implicit, explicit, or inverse mapping to reconstruct a sample from the low-dimensional representation. The presented dimensional reduction technique allows extracting only relevant features that are useful for the further claim data processing while eliminating redundant and unnecessary features. The applied reduction technique allows to reduce the computation time and storage space requirements. For example, reducing dimensions from 100 to 2D or 3D will certainly reduce storage requirement. Moreover, 2D or 3D will provide better interpretation and visualization of data. By eliminating redundant and irrelevant features, the applied dimensional reduction technique is important for the integration of the various claim data sets. The presented technique can be implemented as an extended unsupervised linear mapping based on an eigen vector search and suitable for Gaussian data. Different strategies can be used for reducing the dimensionality of feature space and for preserving the maximum amount of variance of the original claim data. The inventive structure can use different structures including eigen values, latent variable analysis, factor analysis or Linear Regression (LR). Thus, first a set of uncorrelated features or principal components are identified by the system. This allows to define a high dimensional feature space. However, instead of calculating a co-variance of matrix, the inventive technique uses the principal eigen vectors of a kernel matrix. To provide modelling of relations present in the claim data in a nonlinear manner, kernel methods, the method avoids explicit mapping to learn a nonlinear function. The method is able to extract nonlinear principal components using less computation power. Further, it offers good encoding for the claim data having nonlinear manifold. In principle, the input data Y are transformed by the system from original claim input space to kernel space for each data point using nonlinear transformation. The inner product of new feature vectors is used to form a kernel matrix K. Then, the identification of the principal components is used on the centralized K to generate the covariance matrix of the new feature vectors. The kernels can e.g. include Radial, Gaussian, Polynomial, and Hyperbolic tangent. New blocks can be added dynamically and non-iteratively, and old blocks can be removed from the claim data. Thus, the inventive method can be shown to provide significant improvement in signal processing and process monitoring. To monitor the nonlinear dynamic processes, a dynamic principal component kernel can be introduced that achieved higher accuracy with minimum delay.

Further, the data modelling module 5 may comprise a text mining structure 53 for analyzing textual data of the claims channels data sets, like for example the textual data 9123 listing damaged property inventory. The text mining structure 53 is realized as an information extraction and/or selection algorithm to identify and categorize claims, policy and/or services characteristics in the textual data as validated data. Additionally, the text mining structure 53 may be designed to retrieve valuable information data from unstructured text, provide summaries of the claims processing status and/or the integrated claims processing data set, index documents, and more. The data machine learning structure 52 and the text mining structure 53 support the data validation structure 51 during the data validation step 301 for creating the structured data sets 302 and the integrated claims processing data set. The data modelling module stores the structured data and the integrated claims processing data set in the storage module 4 for future use or for on time claim processing in a data storage step 303.

The digital claim system 1 can e.g. automatically confirm and validate receipt of documents upon receipt (ID, death certificate, claim form, medical reporting). Further, the digital claim system 1 can e.g. comprise interfaces to incorporate systems to validate data and information. As such, the digital claim system 1 can e.g. set up integration with services such as Medicare e.g. downloading health history from mygov, verifying identities with digital ID and/or accessing death verification services (IDMatch). Further, auto-assessment can e.g. at least be based on medical condition to policy terms. In particular, e.g. trauma claims can have one or more defined criteria to meet to allow for the claim to be processed and decided. This will be the current policy and in most cases also the policies that have come between application and the date of incident plus industry standard criteria such as what is defined in the Life Insurance Code of Practice. The system 1 can e.g. also be built with this criteria defined (e.g., trauma claim for cancer requiring the event to take place during the period of risk-transfer (insurance) and for the diagnosis of metastatic cancer with spread to surrounding tissue.) This can e.g. be extracted from the reporting or updating of key fields by the treating doctor which will then trigger that the claim should be automatically covered by monetary transfer.

The digital system, 1 can e.g. provide web-enabled graphical user interfaces (GUI) providing claim input forms completable online by medical practitioner. Thus, the digital system 1 can provide electronic claim forms and medical reports to doctors and practitioners via electronic forms where they can e.g. complete online and upload medical reporting to support the review. By filling out defined fields, this can e.g. automatically trigger key criteria in the digital claim system 1 indicating whether key criteria have been met for the claim to be covered (e.g. the doctor indicating that there has been elevated troponin in the heart and a death of a portion of the heart muscle will e.g. trigger the claim to be covered, i.e. paid). The digital system 1 can e.g. automatically generate reports summarizing medical reports and chronology. It is to be noted that medical reporting is often supplied with many pages (50 pages+ is not uncommon). This normally takes a significant amount of time to review and draw a summary (often hours of an assessor's time). The present digital system 1 allows to automate the process by using and applying OCR and AI to develop a chronology and summary of dates and key information. Again, the digital system 1 can e.g. provide automated guidance for additional assessment of the claim which require review by an expert claim assessor, e.g. by generating appropriate electronic flags, for example, comprising triggers (i) triggering for claims lying within 3 years of application, (ii) triggering for claims having an occupation match to the occupation at application, and (iii) triggering for claims with the medical condition pre-dating policy inception, and (iv) triggering for claims with a client job attached (which is indicating a potentially lengthier duration and requirement of rehabilitation support).

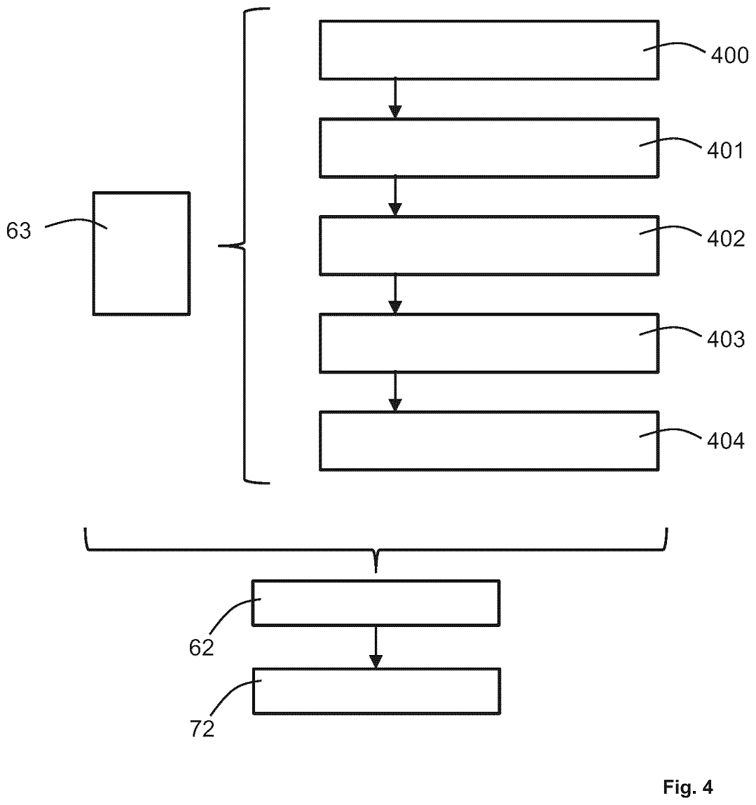

The structured data sets 302 stored in the storage module 4 can e.g. be provided to the claims processing module 6 of the cloud-based infrastructure platform 2 for further processing in a claims processing step 304. The claims processing module 6 comprises a processing and analyzing structure 61 designed for analyzing the structured data sets 302 according to claims requirements defined in the claims channels. That is for example, the processing and analyzing structure 61 evaluates the structured claims data set with reference to the policy rules as defined in the structured policy data set and the structured services data set. For example, the claims event E described by the X-ray imagery data and/or laboratory measurements and/or diagnosis parameter values and/or measuring data form telematics' or wearables' sensors can be extracted and mapped to structured data sets 302 according to claims requirements defined in the digital claims channels. Accordingly, in case of property damage, the imagery data of damaged property 9121 included in the structured claims data set is compared to the age data of the insured property 9341, the size data of the insured property 9342 and the probability data for an occurrence of a natural hazard at the location of the property 9343 as stated in the structured policy data set. The processing and analyzing structure 61 comprises a claim processing status algorithm 63 (see FIG. 4) to define a current claim processing status 305 In accordance with the outcome of the claims processing step 304.

In one example embodiment of the claims processing module 6 according to the invention the processing and analyzing structure 61 of the claims processing module comprises several workflow algorithms, wherein each workflow algorithm defines a processing step of a claims processing workflow. As shown in FIG. 4, there is a workflow algorithm at least for the workflow processing steps of recording of a claim submission by a customer 400, analysis of missing data information 401, analysis of incorrect data information 402, analysis of claim entitlement 403 and recording of a settlement decision 404. The workflow algorithms can transmit their results as output data to the claim processing status algorithm 63 of the processing and analyzing structure 61 to determine the current claims processing status 305. According to these workflow processing steps, the current claims processing status can for example be determined as a claim submission status 305/1, missing data status 305/2, incorrect data status 305/3, claim entitlement status 305/4 and settlement status 305/5.

As mentioned above, the workflow algorithm for the recording of a claims submission 400 for example initiates a claims processing case, labels the claims processing case for further processing and identifies policies related to the claims processing case. The workflow algorithm for the analysis of missing data 401 for example checks the existence or sufficiency of claims data to satisfy policy requirements and identifies missing claims data for claims characteristics needed to comply with policy requirements. Information of the missing data can be provided for the current claims processing status algorithm 405. The workflow algorithm for the analysis of incorrect data 402 for example compares structured claims data, structured policy data and/or structured services data with data of other claims channels of the insurance portfolio of the customer or data of measuring devices measuring physical characteristics related to the claims event. The workflow algorithm for the analysis of incorrect data 402 may identify inconsistencies and quantify any deviation between data information and provide the results as part of the current claims processing status algorithm 405. The algorithm for the analysis of claim entitlement 403 for example aligns the structured claims data set with the structured policy and/or services data sets to approve or reject the claims request of the customer and identify any misalignment as basis for claim rejection. Again, the result can be provided for the current claims processing status algorithm 405. The workflow algorithm for the recording a claim settlement 404 for example determines type and amount of indemnification and monitoring deadlines, and transfers the information to the current claims processing status algorithm 405.

The current claim status as determined by the claims processing status algorithm 63 of the processing and analyzing structure 61 is transmitted to the communication module 7. A notification algorithm 72 of the communication module 7 is configured to create a notification signal to be transmitted to the user devices 191, 192 for notifying the customers and service providers, The signal generator 71 of the communication module 7 provides a digital communication or notifications signal 73 representing the current claim processing status 305, is transmitted to a user device 191, 192 within the digital network 2.

In the example embodiment of the cloud-based infrastructure platform 2 as shown in FIG. 2, the claims processing module 6 comprises a prioritizing structure 62 for identifying and prioritizing outstanding work tasks as defined in a claims processing workflow, like the workflow illustrated in FIG. 4. The workflow algorithms provide their output data to the prioritizing structure 62. The prioritizing structure 62 analysis the workflow data for example according to a work task hierarchy list to classify open work tasks according to their hierarchy and priority, respectively, and may classify the work task priority as output data for the communication module 7.

Further, the example cloud-based infrastructure platform 2 in FIG. 2 hosts a tracking module 10 designed for tracking the claim processing status and creating notification data regarding the claim processing status, incorrect claim data/information, missing claim data/information, outstanding work tasks and/or work task allocation. The notification algorithm 72 of the communication module 7 creates notification data for a notification signal 73 to a customer user device 191 or a notification signal 74 to a service provider user device 192. The notification signals 73, 74 may for example specify missing claim data or information and allocate the work task of providing the missing data for example to the user or a service provider personal. The tracking module 10 may track all workflow steps as mentioned above from the beginning of a claim submission 400 to the recording of a settlement 404. The tracking module 10 may differentiate work tasks for customers and work tasks for services providers. Instead of in the communications module 7, the notification algorithm 72 may be build-in in the claims processing module 6 or the tracking module comprise 10. Further, the cloud-based infrastructure platform 2 hosts a timeline module 11 configured for indicating key data of the claims processing data set on a timeline, wherein the key data at least indicate a policy activation date, a claim event date, a claim submission date and a claim settlement date. Further, the timeline module 11 may indicate for example deadlines for work tasks of the workflow as indicated above and time periods for completing workflow steps. Also, the cloud-based infrastructure platform may host a dashboard module 12, which is for example linked to the storage module 4, the claims processing module 6, the tracking module 10 and/or the timeline module 11. The dashboard module 12 is realized to create a visual display of at least the current claim processing status 305 and/or a communication or notification signal data 73, 74. The visual display may for example be indicated on screens of the user devices 191, 192. Finally, the cloud-based infrastructure platform 2 may host an authentication module 13 providing authentication and authorization credentials for a user and allowing access to the digital claims processing system 1 via the digital network 3, and a document management module 14 screening and archiving any documents related to the claims channels.

The digital claims processing system 1 comprises a number of built-in structures and algorithms that can be amended, updated, or extended on an individual basis, which results in a transparent and efficient interaction and communication with customers. The tracking module and the notification algorithm may create reminder notification to achieve a positive customer outcome. The data modelling module and the claims processing module with the workflow algorithms ensure a satisfying level of compliance and risk management. Claims assessors, like insurance carriers, and customers can collaborate for an efficient customer journey. model is scalable and has been inspired by industry standard data model. The digital claims processing system 1 combines data from the claim form, policy admin system and product rules to nudge users by means of notification signals to enter correct data.

### REFERENCE SIGNS

1 Digital claims processing system
2 Cloud-based infrastructure platform
3 Data transmission network
   31 Network interfaces
4 Storage module/Repository unit
5 data modelling module
   51 data validation structure
   52 machine learning structure
   53 text mining structure
6 claims processing module
   61 processing and analyzing structure
   62 prioritizing structure
   63 claims processing status algorithm
7 communications module
   71 signal generator
   72 notification algorithm
   73 communication/notification signal to customer
   74 communication/notification signal to services providers
10 tracking module
11 timeline module
12 dashboard module
13 authentication module
14 document management module
81 customer interface
82 policy/services interface
83 physical measure interface
91 claims data set
   911 claim data set customer A
      9111 speed at the time of collision
      9113 location of the collision
   912 claim data set customer B
      9121 imagery data of damaged property
      9123 textual data
   913 claim data set customer C
      9131 body function parameter data
      9133 body imagery data
92 services data sets
   921 services data set of service provider F
      9211 maximum distance of travel
   922 services data set of service provider G
      9221 number of service visits
   923 services data set of service provider H
      9231 risk factor classification
93 policy data sets
   931 accident policy data set
      9311 age of the insured person
      9312 gender of the insured person
      9313 probability for an occurrence of an accident
   932 life policy data set
      9321 age of the insured person
      9322 measurable health condition parameter value
      9323 probability for a defined life expectancy
   933 car policy data sets
      9331 age of the insured car
      9332 horsepower of the insured car
      9333 probability for an occurrence of a total loss
   934 property policy data set
      9341 age of the insured property
      9342 size of the insured property
      9343 probability for an occurrence of a natural hazard
   935 health policy data set
      9351 age of the insured person
      9352 measurable health condition parameter value
      9353 probability of a severe illness type
94 risk-transfer product data set
191 customer user device
192 services provider user device
194 measuring device
195 measuring device storage
196 measuring data
200 cellular mobile network
201 satellite transmission line
300 data set input step
301 data validation step
302 structured data sets
303 storage step
304 claims processing step
305 claims processing status
400 recording of a claims submission
401 analysis of missing data
402 analysis of incorrect data
403 analysis of claim entitlement
404 recording of a settlement decision
A customer
B customer
C customer
E claim event
F service provider
G service provider
H service provider

1. A digital life and/or health claims processing system for electronically integrating multiple digital claims channels, where a claims channel includes a claims data set of claims characteristics related to a claim event, a policy data set of policy characteristics related to a claim policy regarding the claim event, a services data set of services characteristics related to claims services, and/or a risk-transfer product data set of product characteristics related to a product, and for processing one or more claims of a customer based on at least one digital claims channel related to the customer, the system comprising:
a cloud-based infrastructure platform accessible via a digital network and configured to host a storage module, a data modelling module, a claims processing module, and a communication module including a signal generator; and
at least one data transmission interface configured to exchange data and/or information provided by at least one user device with the infrastructure platform via the digital network,
wherein at least the claims data set, the policy data set, and/or the services data set includes claimants doctors and/or medical cause data at least including measuring data for physical characteristics values quantifying the claim event and/or historic policy disclosure parameter values and/or product rule parameters and medical cause data and/or diagnostic measuring parameter values and/or laboratory measuring parameter values and/or measuring data for physical characteristics values quantifying a life or health claim event,
wherein the data modelling module includes a data validation structure configured to validate data of characteristics values of the claims data sets, the policy data sets, and/or the services data sets received via the data transmission interface,
wherein validated data sets of the multiple claims channels of the customer are stored as structured data sets in the storage module,
wherein the claims processing module includes a processing and analyzing structure configured to analyze the structured data sets according to claims requirements defined in the digital claims channels, and to define a claim processing status, and
wherein the communication module provides a digital communication signal representing the claim processing status via the signal generator to a user device within the digital network.

2. The system according to claim 1, wherein at least the policy data set includes the historic policy disclosure parameter values, and/or the product rule parameters and the medical cause data and/or the diagnostic measuring parameter values, and/or the laboratory measuring parameter values.

3. The system according to claim 1, wherein at least the policy data set includes the measuring data for physical characteristics values quantifying a life or health risk event exposure and/or a probability for an occurrence of a life or health risk event captured by diagnostic data, laboratory measuring data, and/or on-body sensor devices.

4. The system according to claim 1, wherein a plurality of combined structured data sets of a plurality of customers is stored in the storage module.

5. The system according to claim 1, wherein the multiple claim channels include policy data sets of policy characteristics and/or and service data sets of services characteristics related to historical, outdated, or retired claim policies.

6. The system according to claim 1, wherein the data transmission interface is realized as an application programming interface providing digital applications access between the infrastructure platform and user devices.

7. The system according to claim 1, wherein the data modelling module combines a structured claims data set, a structured policy data set, and/or a structured services data set referring to the claim event to an integrated claims processing data set, which includes structured measuring data for physical characteristics values quantifying a claim life or health event and/or structured measuring data quantifying a life or health event impact exposure and/or a probability for an occurrence of a life event or health event or critical illness event or terminal illness event impacting physically an individual and capturable by sensor or measuring laboratory or diagnostic devices.

8. The system according to claim 1, wherein
the data modelling module comprises a machine learning structure configured to analyze data sets of the claims channels,
the machine learning structure is realized as a supervised or unsupervised machine learning algorithm configured to analyze input data sets and to provide validation for the data of the input data sets, and
the data modelling module provides the validated data for the structured data sets.

9. The system according to one of claim 1, wherein
the data modelling module comprises a text mining structure configured to analyze textual data of the claims channel data sets,
the text mining structure is realized as an information extraction module and/or interface configured to identify and to categorize claims, policy, and/or services characteristics in the textual data as validated data, and
the data modelling module provides the validated data for the structured data sets.

10. The system according to claim 7, wherein
the data modelling module comprises a machine learning structure for dimensionality reduction of the integrated claims processing data set, and
the machine learning structure is realized to select and/or extract data variables from the claims channel data sets and/or the structured data sets to simplify the integrated claims processing data set.

11. The system according to claim 1, wherein
the processing and analyzing structure of the claims processing module includes several workflow algorithms, and
each of the workflow algorithms defines a processing step of a claims processing workflow.

12. The system according to claim 11, wherein the processing and analyzing structure includes workflow algorithms at least for workflow processing steps of recording of a claims submission by a customer, analyzing of missing data information, analyzing of incorrect data information, analyzing of claim entitlement, and recording of a settlement decision.

13. The system according to claim 1, wherein the claims processing module includes a prioritizing structure configured to identify and prioritize outstanding work tasks in a claims processing workflow.

14. The system according to claim 7, wherein the cloud-based infrastructure platform hosts a tracking module configured to track the claim processing status and to create notification signals regarding the claim processing status, incorrect claim data/information, missing claim data/information, outstanding work tasks, and/or work task allocation.

15. The system according to claim 14, wherein the claims processing module, the communication module, and/or the tracking module include a notification algorithm configured to create notification data for a notification signal for allocating work tasks and/or requesting missing claim data/information.

16. The system according to claim 15, wherein
the cloud-based infrastructure platform hosts a timeline module configured to indicate key data of the integrated claims processing data set on a timeline, and
the key data at least indicates a policy activation date, a claim event date, a claim submission date, and a claim settlement date.

17. The system according to claim 16, wherein
the cloud-based infrastructure platform hosts a dashboard module, which is linked to the storage module, the claims processing module, the tracking module, and/or the timeline module, and
the dashboard module is configured to create a visual display of at least the claim processing status and/or the communication signal.

18. The system according to claim 6, wherein
the user devices are network-compatible devices, and
the cloud-based infrastructure platform hosts an authentication module configured to provide authentication credentials for a user and allowing access to the digital claims processing system.

19. A method for a digital claims processing system including integrated and automated digital multiple claims channels and for processing one or more claims based on the multiple claims channels,
wherein a claims channel includes a claims data set of claims characteristics related to a claim event, a policy data set of policy characteristics related to a claim policy regarding the claim event, and/or a services data set of services characteristics related to claims services,
wherein at least the claims data set, the policy data set, and/or the services data set includes measuring data for physical characteristics values quantifying a claim event and/or historic policy disclosure parameter values and/or product rule parameters and medical cause data and/or diagnostic measuring parameter values and/or laboratory measuring parameter values, and
wherein a cloud-based infrastructure platform of the digital claims processing system is accessible via a digital network, the method comprising:
exchanging data sets from the multiple digital claim channels and/or information between the cloud-based infrastructure platform and at least one user device via at least one data transmission interface via the digital network,
validating, via a data modelling module of the digital claims processing system including a data validation structure, data of characteristics values of the claims data sets, the policy data sets, and/or the services data sets received via the data transmission interface,
storing validated data as structured data sets in a data storage module of the digital claims processing system,
processing, via a claims processing module of the digital claims processing system including a processing and analyzing structure, the structured data sets according to requirements of structured policy data sets and/or structured services data sets referring to the claim event,
analyzing and determining, via processing and analyzing structure, a claim processing status, and
providing, via a communication module of the digital claims processing system a communication signal of the claim processing status to a user device via a signal generator within the digital network.

20. The method according to claim 19, further comprising:
creating, via a notification algorithm, a notification signal for requesting missing claim data and/or information, and
providing the notification signal to the communication module for transmission to the user device using the signal generator.

21. The method according to claim 19, further comprising following a claims processing workflow for processing a structured claims processing data set, the claims processing workflow at least including processing steps of recording of a claims submission by a customer, analyzing of missing data information, analyzing of incorrect data information, analyzing of claim entitlement and recording of a settlement decision.

22. The method according to claim 19, further comprising:
Identifying an outstanding work task in the claims processing by a prioritizing algorithm of the claims processing module,
prioritizing the outstanding work task, and
providing a notification signal to a tracking module of the digital claims processing system.

23. The method according to claim 21, further comprising analyzing, via a machine learning structure, the claims data sets, the policy data sets, the services data sets, and/or the structured claims processing data set of the digital claims channels for optimizing work task recognition.
